(19) United States
(12) Patent Application Publication
(10) Pub. No.: US 2006/0249033 A1
(43) Pub. Date: Nov. 9, 2006

(54) Monitoring device for a baking apparatus

(76) Inventors: Dieter Engelhardt, Bischbrunn (DE); Peter Leppich, Arnstein (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/402,294

(22) Filed: Apr. 11, 2006

(30) Foreign Application Priority Data
Apr. 11, 2005 (DE) 10 2005 016 766.7

(51) Int. Cl. A23C 3/00

(52) U.S. Cl. 99/468; 426/523

(57) ABSTRACT

The invention relates to a baking apparatus including an oven, a heating device, and a transport device for the transport of dough slabs through the interior of the oven. The heating device and the transport device are fed with an operating current. Further, the apparatus includes at least one monitoring device for monitoring the operating current of at least one of the two devices, and which increases the operational reliability of the baking apparatus. The monitoring device has at least one interface for outputting of a monitoring signal.

### TECHNICAL FIELD OF THE INVENTION The invention relates to a baking apparatus.

### BACKGROUND OF THE INVENTION

A baking apparatus is known, for example, from document DE 30 12 043 C2, which is incorporated herein by reference. This describes a baking apparatus with an oven which has an infeed opening in its upper wall and a delivery opening in its lower wall. Individual dough slabs, which in the present case are shaped as longish white loaves, referred to in French as baguettes, are fed in by way of a divider designed as a cellular wheel. The dough slabs are preferably par-baked dough products (dough shapes). By means of the divider designed as a cellular wheel they are brought into a position above a gondola pan of a gondola conveyor and drop into the gondola pan as the cellular wheel continues to turn. The gondola pan forms the carrying means for the dough slabs. The gondola conveyor is located in the oven's baking compartment. It includes two parallel conveyor chains following a winding course by means of which the gondola pans filled with dough products are transported through the baking compartment of the oven.

Accordingly, it is desirable to increase the operational reliability of such a baking apparatus.

### SUMMARY OF THE INVENTION

It is possible to detect numerous malfunctions or failures of the baking apparatus in good time by monitoring the operating current. Due to the monitoring signal, an alarm signal may either be outputted on the baking apparatus itself or an error log may be generated which provides a technician with valuable information for maintenance of the baking apparatus.

In a first embodiment of the invention, the operating current of the heating device is monitored. The heating device consists preferably of heating means, especially heating rods, which are in balanced connection with a 3-phase alternating current supply. This means that each of the 3 phases of the alternating current supply is loaded with the same heating current. The neutral conductor of the alternating current supply conducts no current under balanced load. If a heating rod fails, the balanced nature of the load on the three phases is lost and current flows through the neutral conductor of the heating device.

This current flow can be detected in particular by a measuring signal of an inductive transducer. The inductive transducer can, for example, be designed as a coil through which the neutral conductor of the alternating current supply passes. As soon as a heating rod fails, the operating current of the heating device flowing through the neutral conductor is detected. Failure of a single heating rod does not result in the oven's function being significantly impaired. A high-quality oven for food production has a large number of heating rods, twelve heating rods for example. If one heating rod fails, the oven is able to compensate for this failure, e.g. one or more heating rods may be brought into circuit or the oven's controller may modify the baking program accordingly and extend the length of time the dough slabs remain in the oven.

However, the signal which signals the failure of a heating rod also provides information that a heating rod must be replaced no later than at the next maintenance.

Alternatively or additionally, the operating current of a drive motor of the transport device may be monitored. The operating current of the motor is a measure of the output delivered by the motor. If this output exceeds a normal value, the transport device's resistance is too high. This may be attributable to the transport device being dirty or damaged and is again a cause for maintenance work on the baking apparatus.

In a practical embodiment, the drive motor is fed by way of a current converter and the current converter works as a monitoring device. Modern current converters, which are digitally controlled to provide the optimum operating current for the drive motor, detect the operating current intensity delivered via their internal components or circuits. A signal which reflects this operating current intensity can be picked up on the current converter and used as a monitoring signal.

Furthermore, there may also be a motion sensor which detects the movement of the transport device and transmits a monitoring signal associated with this movement by way of an interface.

The transport device may come to a complete standstill if it is seriously damaged or jammed. This standstill is detected by the motion sensor. If the transport device comes to a standstill, the dough slabs on the transport device remain in the oven. In this case it is necessary to switch the oven off to prevent these dough slabs from burning. Furthermore, it is expedient to switch off the drive motor's operating current so that it does not transmit any forces to the jammed transport device and does not become damaged itself.

The monitoring signals referred to above may be stored on a data storage device. Such storage is expedient particularly in respect of the current intensity of the drive motor's operating current or in respect of the monitoring signal with regard to the heating current. It is possible, as mentioned, to infer minor irregularities and occurrences of wear in the baking apparatus from the signal curve. The curve of the monitoring signal stored in the data memory may be used during maintenance work to analyse possible faults in the baking apparatus.

In this regard the monitoring signal may be stored continuously. Alternatively the monitoring signal may be stored at specified intervals. It is also possible to store the monitoring signal if a maximum or minimum threshold value is exceeded. The heating current in the neutral conductor of the 3-phase current supply is usually negligibly small and only has to be stored if it exceeds a specific threshold value which signals the failure of a heating rod.

A preferably digital evaluation unit analyses the monitoring signal and determines whether previously specified threshold values have been exceeded or have not been reached. The evaluation unit can also establish a more complex analysis such as the speed at which the signal rises or similar.

The monitoring signal can likewise activate an alarm device assigned to the baking apparatus if a threshold value is exceeded. The alarm device may, for example, be a read-out on a display on the baking apparatus. It may additionally be a visual signal in the form of a signal light. Further, it may be an acoustic signal which is transmitted through a loudspeaker.

Finally, it is possible to transmit the monitoring signal to a remote monitoring station via a data network. This makes it possible to carry out remote maintenance of the baking apparatus. For example, the manufacturer of the baking apparatus can collect and evaluate the monitoring signals of all networked monitoring devices in a monitoring centre. A maintenance team can be commissioned with maintenance of the baking apparatus if the monitoring signals assume critical values. The manufacturer's technicians or fitters can also use the monitoring signals transmitted in the preparation of routine maintenance work. The monitoring signals make it possible to determine what maintenance work is necessary for the baking apparatus concerned.

The evaluation unit is preferably disposed in the monitoring station for this remote monitoring.

Any data networks may be used for transmission of the monitoring signals. An analog or digital telephone network may be used to transmit the data if a telephone cable is laid in the operating room of the baking apparatus. Likewise a wireless telephone network may be used if access to the network is possible at the location where the baking apparatus is operated. The GSM wireless telephone network can usually be used for signal transmission. It is also possible on the basis of the monitoring signals to generate text messages which are transmitted via what is known as the SMS protocol as a short message on the GSM telephone network. Finally, any data transmission protocols may be used in the GSM network such as GPRS for example. Likewise digital wireless data networks such as UMTS or wireless or wired local area networks may also be used for transmission of the monitoring signals.

As already mentioned, the baking apparatus may have a control unit which switches off the operating current of the heating device and/or the transport device if a threshold value is exceeded.

Any motion sensors may be used to detect the movement of the transport device discussed. For example, a light barrier, which detects alternating light signals depending on the movement of the carrying means and converts them into corresponding monitoring signals, may be disposed in the movement path of the transport device's carrying means. A sliding contact may also be provided which co-operates with a metallic part of a carrying means moved past it and generates a monitoring signal based on the contact. In the case of a metallic carrying means, it is possible to use a contact-free sensor, especially a magnetic sensor, close to the movement path of the carrying means.

### BRIEF DESCRIPTION OF THE DRAWINGS

Embodiments of the invention are described in the following on the basis of the drawings attached, in which:

FIG. 1 is a side view of a baking apparatus according to one embodiment of the invention;

FIG. 2 is an enlarged side view of the heating device of the baking apparatus according to one embodiment of the invention;

FIG. 3 is a top view of the heating device from FIG. 2;

FIG. 4 is a schematic circuit diagram of the current supply for the heating device from FIGS. 2 and 3;

FIG. 5 is a schematic circuit diagram of the current supply of the transport device's drive motor according to one embodiment of the invention; and

FIG. 6 is a schematic diagram of the networking of the baking apparatus according to one embodiment of the invention.

### DETAILED DESCRIPTION OF VARIOUS EMBODIMENTS OF THE INVENTION

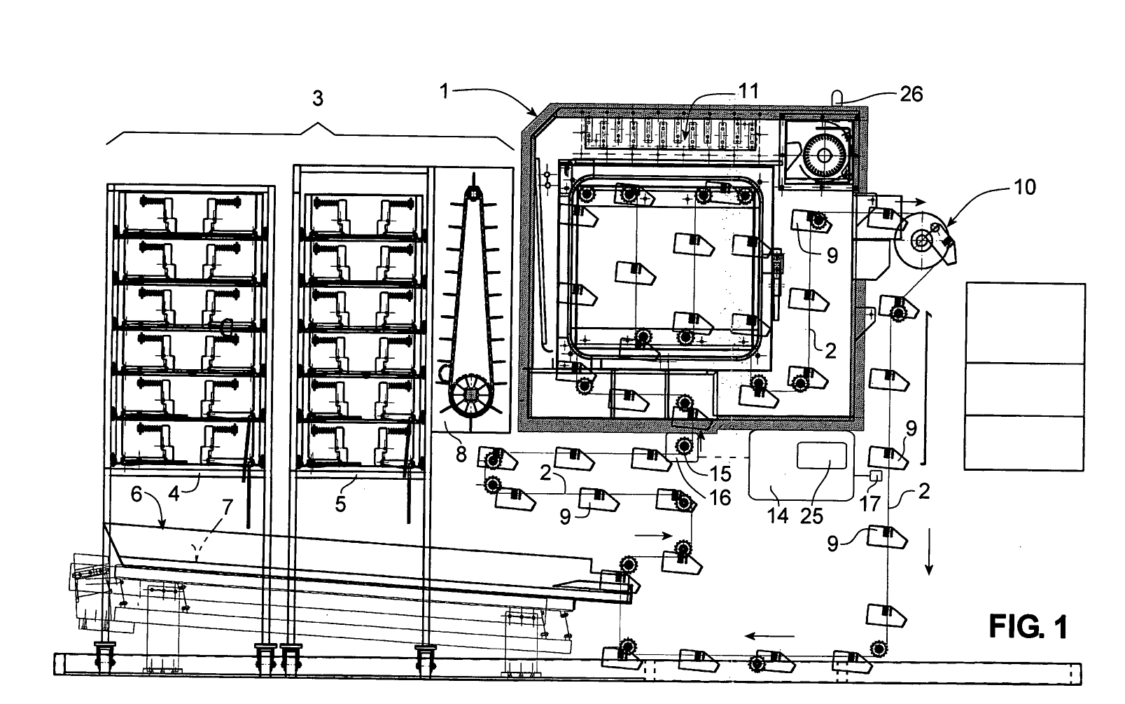

The baking apparatus shown in FIG. 1 comprises an oven 1 for baking dough slabs or dough shapes, which are mostly slightly defrosted, completely thawed or deep-frozen and/or par-baked and which are fed automatically into the baking compartment of oven 1 by a transport device. Oven 1 is thermally insulated and has an inspection window on the side visible in FIG. 1. The side wall of oven 1 is shown as transparent to make the layout clearer. The dough slabs are not shown in FIG. 1.

A transport device which has a pair of conveyor chains 2 circulating at a distance from and parallel to each other is provided for transporting the dough slabs into oven 1. Again for reasons of clarity, the course of conveyor chains 2 is only illustrated by a thin line in FIG. 1. As conveyor chains 2 also run through the heated baking compartment of oven 1, they are preferably manufactured from heat-resistant materials, especially from steel.

Further, the baking apparatus in FIG. 1 comprises an infeed device 3 which consists of a plurality of elements. On one hand two loading trolleys 4 and 5 may be seen on which dough slabs, especially par-baked rolls, are disposed in different layers. Underneath loading trolleys 4 and 5 is disposed a trough 6, the bottom surface of which forms an inclined sliding surface 7.

Whilst loading trolleys 4 and 5 transport dough slabs for rolls which fall onto sliding surface 7, a supply magazine 8 for longish bakery products, especially baguettes, is disposed on the side of loading trolley 5 facing towards oven 1.

Between conveyor chains 2 are disposed carrying means 9 each running at right angles which pick up the dough slabs and transport them into the baking compartment of oven 1. In the baking compartment of oven 1, transport chains 2 which are parallel to each other follow a winding course so that carrying means 9 remain inside the baking compartment of oven 1 for a sufficiently long time. Carrying means 9 are attached to the pair of conveyor chains in the manner of a gondola. For this they are attached so as to be pivotable around an axis running at right angles to pair of conveyor chains 2. Due to their centre of gravity being below the axis of rotation, they remain, without any external influence, in the position shown in FIG. 1 in which their contact surface runs essentially horizontally or if necessary is inclined at a slight angle towards the bottom right-hand side of FIG. 1.

At the exit from the baking compartment of oven 1 is provided a delivery station 10 at which the fully baked bakery goods are removed from carrying means 9.

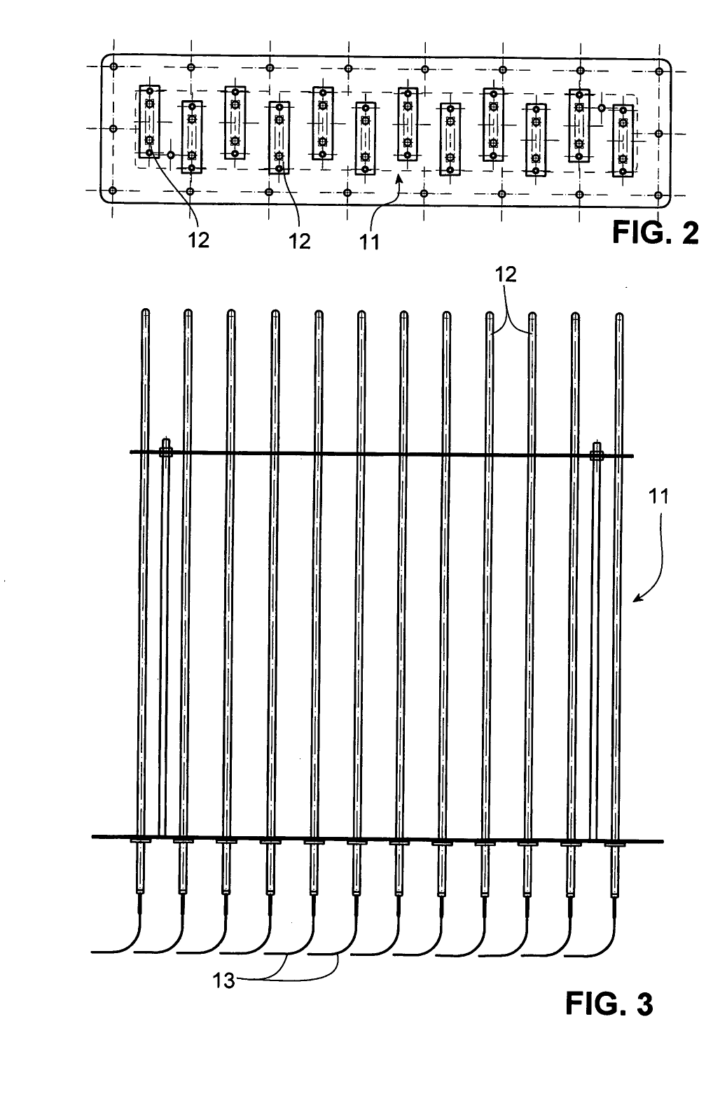

In the top section of oven 1 a heating device 11 disposed inside oven 1 can be seen which is shown in greater detail in FIGS. 2 and 3. Heating device 11 consists of twelve U-shaped heating rods 12 offset to one another, each of which is connected to a power supply by way of a connection cable 13. The power supply is accommodated in control box 14 represented schematically underneath oven 1 in FIG. 1.

Further, a drive pinion 15, which meshes with conveyor chain 2, is driven by a drive motor 16. Drive motor 16 drives a corresponding pinion on the opposing side in the same direction of rotation. Drive motor 16 is likewise connected to a power supply inside control box 14.

Finally, a motion sensor 17 linked to control box 14 can be seen in FIG. 1. Motion sensor 17 contains a coil and works by induction. Each time a carrying means 9 passes by at a short distance from motion sensor 17, said sensor outputs a signal which is routed to control box 14 by way of a signal cable.

It is possible to establish proper operation of conveyor chain 2 based on the signal from motion sensor 17. An evaluation unit in control box 14 can determine by way of the motor current whether conveyor chain 2 is being driven. If conveyor chain 2 is being driven, signals from motion sensor 17 must be detected periodically when metallic carrying means 9 pass by said motion sensor 17. If this signal is not detected, it may be assumed that conveyor chain 2 is jammed. In this case, control box 14 switches off heating device 11 of the oven and the power supply of drive motor 16.

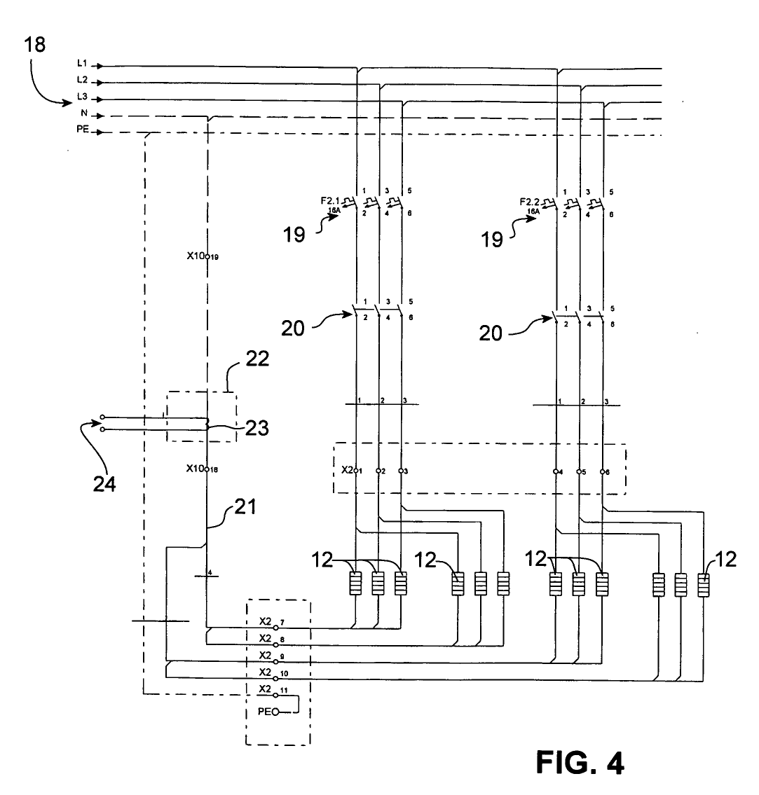

FIG. 4 shows the power supply for the twelve heating rods 12. Heating rods 12 are in balanced connection with a 3-phase alternating current supply 18. Heating rods 12 are furthermore fuse-protected in two groups by means of fuses 19 and contactors 20.

As mentioned, with the present balanced connection of heating rods 12, no current flows through neutral conductor 21 of the arrangement if the heating rods are fully capable of functioning. Only if one heating rod 12 fails, does the load on the three phases of supply 18 become unbalanced, and a current flows through neutral conductor 21. An inductive current sensor 22, which has a coil 23 through which neutral conductor 21 passes, is provided to detect this current. Connection terminals 24 of the coil at which the voltage and the current in coil 23 can be picked up, form an interface of current sensor 22. Connection terminals 24 are connected to a monitoring unit in control box 14.

If a signal which exceeds a certain threshold value is picked up by way of connection terminals 24, it follows that a current flows through the neutral conductor due to the failure of a heating rod 12. The signal can either be stored on a data storage device in control box 14 or it can be displayed by way of a display device, for example on screen 25 on control box 14 (see FIG. 1). It is also possible for a signal lamp 26 on oven 1 to be activated by way of control box 14.

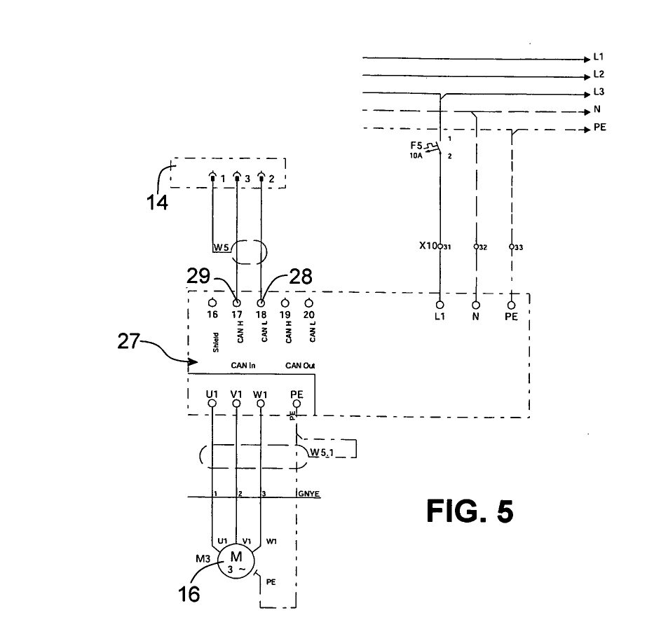

FIG. 5 shows the power supply of drive motor 16 which drives conveyor chains 2 acting as a transport device. Drive motor 16 is fed by a current converter 27. By way of connection terminals 28, 29, which form an interface to the current converter's electronics, it is possible to pick up a signal which corresponds to the current outputted by the current converter to drive motor 16. The signal is passed on to control box 14. Any suitable signal cables or data bus system, e.g. a CAN bus (CAN=Controller Area Network), may be used for signal transmission.

The current of the current converter has a specific setpoint value when the transport device is operating correctly. Expediently, a certain bandwidth, which is limited by an upper and lower threshold value, is specified around this setpoint in the controller. If the current drops below the lower threshold value, it may be assumed that drive motor 16 (FIG. 1) is not generating enough power to drive conveyor chain 2. This is the case, for example, when the power transmission from the motor shaft of drive motor 16 to conveyor chain 2 is faulty.

The power transmitted to conveyor chain 2 becomes too great if the current of drive motor 16 exceeds an upper threshold value. This leads to the conclusion that conveyor chain 2 is too stiff, for example due to excessive friction or due to damage. Dirt or jammed objects may also act as a brake on conveyor chain 2.

The signals of the motor current, heating rod current and motion sensor passed on to control box 14 may be recorded at this point on a data storage device and may be read off and analysed by maintenance staff. However, it is also possible to link the control box to a data network so that the signals are transmitted immediately to a monitoring station.

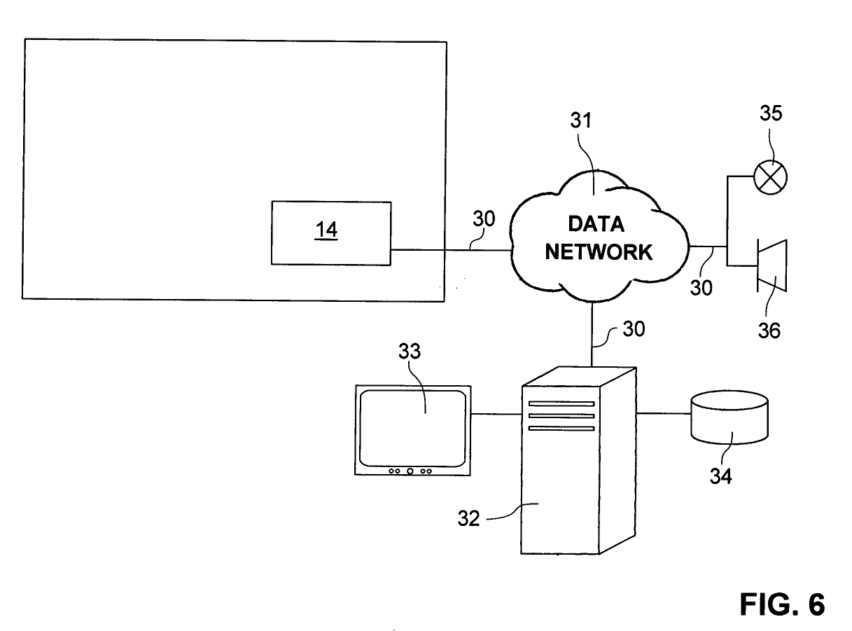

FIG. 6 shows, schematically and not to scale, networking of the baking apparatus according to the invention for the carrying out of monitoring as described above. Control box 14 of the baking apparatus is connected to a data network 31 by way of a data cable 30. Data network 31 may be any network suitable for the transmission of data, preferably in digital form, e.g. a telephone network or wireless telephone network, a wireless data network such as UMTS, the Internet with any access and a local data network, which networks the components of a local data processing system. By way of a further data cable 30, the monitoring signals of control box 14 are transmitted to a monitoring computer 32, which forms a monitoring station for the baking apparatus. Monitoring computer 32 can analyse the monitoring data received and/or store it to a data storage device (e.g. a hard disk drive 34) and/or display it on a display device (e.g. a monitor 33) and/or trigger an alarm signal. A single monitoring computer 23 may form the monitoring station for a plurality of different baking apparatuses that are all connected to data network 31 by way of data cables 30.

Monitoring computer 32 may be located in the same building as the baking apparatus. However, it may also be located in a building belonging to the manufacturer of the baking apparatus or in the building of a service technician and be linked to control box 14 by way of a data network 31 (e.g. the Internet). The same applies to the alarm devices, which are represented in FIG. 6 as signal lamp 35 and as loudspeaker 36 for alarm signals. These alarm devices 35, 36 may be disposed in the immediate vicinity of monitoring computer 32 or remotely from it and be linked to monitoring computer 32 and/or control box 14 of the baking apparatus by way of any data network. Alarm devices 35, 36 may alternatively, by their alarm signals, cause the operator of the baking apparatus to carry out immediate measures or notify a service technician about a significant fault which necessitates immediate maintenance of the baking apparatus.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. Baking apparatus, comprising:
an oven;
a heating device associated with the oven;
a transport device for the transport of dough slabs through the interior of the oven, wherein the heating device and the transport device are fed with an operating current; and
at least one monitoring device for monitoring the operating current of at least one of the heating and transport devices, wherein the monitoring device has at least one interface for outputting of a monitoring signal.

2. The baking apparatus according to claim 1, wherein the monitoring device monitors the operating current of the heating device.

3. The apparatus according to claim 2, wherein the heating device comprises at least one heating means which is in balanced connection with the phases of a 3-phase electricity supply.

4. The baking apparatus according to claim 3, wherein the monitoring device measures and monitors a flow of current through the neutral conductor of the 3-phase electricity supply.

5. The baking apparatus according to claim 1, wherein the monitoring device measures and monitors an operating current of a drive motor assigned to the transport device.

6. The baking apparatus according to claim 5, wherein the drive motor is fed by way of a current converter, and wherein the current converter acts as a monitoring device and generates a current monitoring signal representing a current intensity of the operating current.

7. The baking apparatus according to claim 1, further comprising:
a motion sensor which detects movement of the transport device and transmits a motion monitoring signal assigned to said movement by way of an interface.

8. The baking apparatus according to claim 7, wherein the monitoring signal is stored on a data storage device.

9. The baking apparatus according to claim 8, wherein the monitoring signal is stored continuously.

10. The baking apparatus according to claim 8, wherein the monitoring signal is stored at specified intervals.

11. The baking apparatus according to claim 8, wherein the monitoring signal is stored if a threshold value is exceeded.

12. The baking apparatus according to claim 1, wherein the monitoring signal activates an alarm device assigned to the baking apparatus if a threshold value is exceeded.

13. The baking apparatus according to claim 12, wherein the alarm device transmits an acoustic or optical alarm signal.

14. The baking apparatus according to claim 1, wherein the monitoring signal is transmitted to a remote monitoring station by way of a data network.

15. The baking apparatus according to claim 14, wherein the monitoring signal is transmitted by way of one of the following data networks:
an analog or digital telephone network;
a wireless telephone network;
a wireless data network;
Internet; and
a local area network.

16. The baking apparatus according to claim 1, further comprising:
a control unit which switches off the operating current of at least one of the heating device and the transport device if a threshold value of the monitoring signal is exceeded.

17. The baking apparatus according to claim 7, wherein the motion sensor is at least one of the following sensors:
an optical sensor disposed in the movement path of the transport device;
a sliding contact disposed close to the movement path of the transport device and which touches a transport device moved past it;
a contact-free sensor close to the movement path of the transport device and which detects metal parts of a transport device moved past it.

18. The baking apparatus according to claim 17, wherein said optical sensor is a light barrier.

19. The baking apparatus according to claim 17, wherein said contact-free sensor is at least one of a magnetic and a capacitive sensor.
